(19) United States
(12) Patent Application Publication
(10) Pub. No.: US 2020/0094504 A1
(43) Pub. Date: Mar. 26, 2020

(54) BEAD WRAPPING SYSTEM

(71) Applicant: Bartell Machinery Systems, L.L.C., Rome, NY (US)

(72) Inventors: John Robert Russo, II, Marcy, NY (US); James Robert Barron, Westmorland, NY (US); George Louis Perry, Rome, NY (US); Mike Gene Meisenhelder, Rome, NY (US); Genadiy Ostapuk, Rome, NY (US); Mark David Colangelo, Rome, NY (US); Thomas Francis Lazzaro, Verona, NY (US)

(73) Assignee: Bartell Machinery Systems, L.L.C., Rome, NY (US)

(21) Appl. No.: 16/576,923

(22) Filed: Sep. 20, 2019

Related U.S. Application Data
(60) Provisional application No. 62/734,049, filed on Sep. 20, 2018.

(51) Int. Cl. B29D 30/48

(52) U.S. Cl. CPC B29D 30/48; B29D 2030/487

(57) ABSTRACT

A bead wrapping system for wrapping a strip around a tire bead may include one or more of the following components: an expandable chuck, a strip handling system, and a former assembly. At least one of the strip handling system and the former assembly may be movable radially relative to a central gear of the expandable chuck in response to rotation of the central gear.

### RELATED APPLICATIONS

This application claims the benefit of U.S. Provisional Application No. 62/734,049, entitled BEAD WRAPPING SYSTEM, and filed Sep. 20, 2018, which is hereby incorporated by reference in its entirety.

### BACKGROUND

A vehicle tire generally has two annular bead rings (herein referred to as “beads”) at the innermost diameter, which provides a vehicle tire with hoop strength and structural integrity. The beads also provide stiffness at the point where the tire mounts to a rim. Beads are generally manufactured by winding metal wire in a groove on the outer periphery of a chuck or drum, often called a former. A bead may also be formed from a single wire or multiple wires joined together.

The bead is often attached to a strip made of rubber or another synthetic material. In some tires, this strip extends outward from the outer diameter surface of the bead and is referred to as an apex or filler. The apex or filler generally is applied to the outer periphery of the bead and provides a smooth transitional juncture between each bead and the adjacent side wall of the vehicle tire. An apex is generally applied to a bead through the use of automatic rubber extrusion and profiling equipment and equipment for wrapping the apex or filler around the bead and seaming the two free ends of the strip together.

In other tires, the strip made of rubber or another synthetic material may wrap around the cross-sectional surfaces of the bead along the entirety of the bead's circumference (e.g., such that the inner diameter surface, the outer diameter surface, and the surface(s) therebetween are wrapped and covered by the rubber or synthetic strip). The present embodiments provide improved manufacturing equipment for forming a bead wrapped with a strip of rubber or synthetic material in accordance with this background.

### SUMMARY

A bead wrapping system for wrapping a strip around a tire bead may include one or more of the following components: an expandable chuck, a strip handling system, and a former assembly. At least one of the strip handling system and the former assembly may be movable radially relative to a central gear of the expandable chuck in response to rotation of the central gear.

In some embodiments, an expandable chuck may be included. The expandable chuck may have a plurality of rollers forming an effective diameter of the expandable chuck, a central gear located at the center of the expandable chuck, at least one drive rod mechanically coupled to the central gear and at least one roller base secured to at least one roller of the plurality of rollers. Rotation of the central gear may cause the at least one roller base to move linearly along the drive rod.

In some embodiments, a strip handling system may be included. The strip handling system may have a cutter assembly with an entrance and an exit, a gripper configured to engaged a strip and to move the strip from the entrance towards the exit, a blade configured to cut the strip at a location between the entrance and the exit, and a cutter bar that is rotatable between a cutting position and a default position. The cutter bar may include a support surface configured to contact the strip when the cutter bar is in the cutting position. The strip handling system may also include a drive assembly with at least one drive roller that is movable to engage and disengage the strip at the exit of the cutter assembly.

In some embodiments, a former assembly may be included. The former assembly may be configured for wrapping a strip around a tire bead, the tire bead being ring-shaped to define an axial and a radial direction. The former assembly may include a plurality of former rollers, the plurality of former rollers including at least a first former roller and a second former roller. The first former roller may be movable in the axial direction relative to the second former roller and also in the radial direction relative to the second former roller.

### BRIEF DESCRIPTION OF THE DRAWINGS

The invention can be better understood with reference to the following drawings/figures and description. The components in the figures are not necessarily to scale, emphasis instead being placed upon illustrating the principles of the invention. Moreover, in the figures, like referenced numerals designate corresponding parts throughout the different views.

FIG. 1 is an illustration showing a front view of a bead wrapping system in accordance with certain aspects of the present disclosure.

FIG. 2 is an illustration showing a front view of an expandable chuck for handling a bead in an engaged state in accordance with certain aspects of the present disclosure.

FIG. 3 is an illustration showing the expandable chuck of FIG. 2 in a disengaged state in accordance with certain aspects of the present disclosure.

FIG. 4 is an illustration showing a side view of a central gear and associated bevel gears of an expandable chuck in accordance with certain aspects of the present disclosure.

FIG. 5 is an illustration showing a pair of rollers and associated components of an expandable chuck in accordance with certain aspects of the present disclosure.

FIG. 6 is an illustration showing a pair of rollers of an expandable chuck in a disengaged or retracted position in accordance with certain aspects of the present disclosure.

FIG. 7 is an illustration showing the rollers of FIG. 6 in an engaged or extended position in accordance with certain aspects of the present disclosure.

FIG. 8 is an illustration showing a bead handling assembly for a bead wrapping system in accordance with certain aspects of the present disclosure.

FIG. 9 is an illustration showing a portion of the strip handling system of FIG. 8, including a cutter assembly located on a diameter adjustment assembly in accordance with certain aspects of the present disclosure.

FIG. 10 is an illustration showing a back view showing certain components of the strip handling system of FIG. 8.

FIG. 11 is an illustration showing a back view similar to FIG. 10 but showing a diameter adjustment assembly in an extended state in accordance with certain aspects of the present disclosure.

FIGS. 12-14 are illustrations showing a side view of certain components of the strip handling system of FIG. 8, where each of FIGS. 12-14 shows a different axial position of a strip relative to a bead as the strip is fed towards the bead (e.g., to adjust the wrapping angle) in accordance with certain aspects of the present disclosure.

FIG. 15 is an illustration showing certain components of the strip handling system of FIG. 8, where a portion of an entrance assembly may move axially with a cutter assembly in accordance with certain aspects of the present disclosure.

FIG. 16 is an illustration showing certain components of the strip handling system of FIG. 8, including a drive assembly in an open or disengaged state in accordance with certain aspects of the present disclosure.

FIG. 17 and FIG. 18 are illustrations showing various view of the drive assembly of FIG. 16 in an engaged or driving state in accordance with certain aspects of the present disclosure.

FIGS. 19-20 are illustrations showing an entrance assembly in various states in accordance with certain aspects of the present disclosure.

FIG. 21 is an illustration showing a cutter assembly feeding a strip towards a drive assembly where the drive assembly is in an open or disengaged state in accordance with certain aspects of the present disclosure.

FIG. 22 is an illustration similar to that of FIG. 21 but showing the drive assembly in an engaged or driving state, and thus engaged with the strip, in accordance with certain aspects of the present disclosure.

FIG. 23 is an illustration showing grippers of a cutter assembly engaged with a strip in accordance with certain aspects of the present disclosure.

FIG. 24 is an illustration showing a cutter assembly where a blade and an associated cutter bar of the cutter assembly are in a default, non-cutting state in accordance with certain aspects of the present disclosure.

FIG. 25 is an illustration showing the cutter assembly of FIG. 24 where the cutter bar is rotated into a cutting state in accordance with certain aspects of the present disclosure.

FIG. 26 is an illustration showing the cutter assembly of FIGS. 24-25 where the blade of the cutter assembly is cutting a strip in accordance with certain aspects of the present disclosure.

FIG. 27 is an illustration showing a front view of a former assembly with rollers for pressing a strip against an outer diameter of a bead in accordance with certain aspects of the present disclosure.

FIG. 28 is an illustration showing an example of a wrapping sequence for wrapping a strip around the profile of a bead in accordance with certain aspects of the present disclosure.

FIGS. 29-31 are various illustrations showing a first step of wrapping a strip around a bead with the former assembly of FIG. 27 in accordance with certain aspects of the present disclosure.

FIGS. 32-34 are various illustrations showing a second step of wrapping a strip around a bead with the former assembly of FIG. 27 in accordance with certain aspects of the present disclosure.

FIGS. 35-37 are various illustrations showing a third step of wrapping a strip around a bead with the former assembly of FIG. 27 in accordance with certain aspects of the present disclosure.

FIGS. 38-40 are various illustrations showing a fourth step of wrapping a strip around a bead with the former assembly of FIG. 27 in accordance with certain aspects of the present disclosure.

FIGS. 41-43 are various illustrations showing a fifth step of wrapping a strip around a bead with the former assembly of FIG. 27 in accordance with certain aspects of the present disclosure.

FIGS. 44-45 are various illustrations showing a sixth step of wrapping a strip around a bead with the former assembly of FIG. 27 in accordance with certain aspects of the present disclosure.

FIGS. 47A-47B are illustrations showing a former assembly having lower or bottom rollers that are movable radially (e.g., vertically from the depicted perspective) relative to upper rollers in accordance with certain aspects of the present disclosure.

FIGS. 48A-48B are illustrations showing a partial-cutout view of the former assembly of FIGS. 47A-47B, where the former assembly has front and back rollers, where at least one of the front rollers is movable axially relative to at least one of the back rollers in accordance with certain aspects of the present disclosure.

FIGS. 49A-49B are illustrations showing a side view of the former of FIGS. 47A-48B, specifically depicting two different axial positions of front rollers relative to at least one back roller in accordance with certain aspects of the present disclosure.

### DETAILED DESCRIPTION

The invention is described with reference to the drawings in which like elements are referred to by like numerals. The relationship and functioning of the various elements of this invention are better understood by the following detailed description. However, the embodiments of this invention are not limited to the embodiments illustrated in the drawings. It should be understood that the drawings are not to scale, and in certain instances details have been omitted which are not necessary for an understanding of the present invention, such as conventional fabrication and assembly.

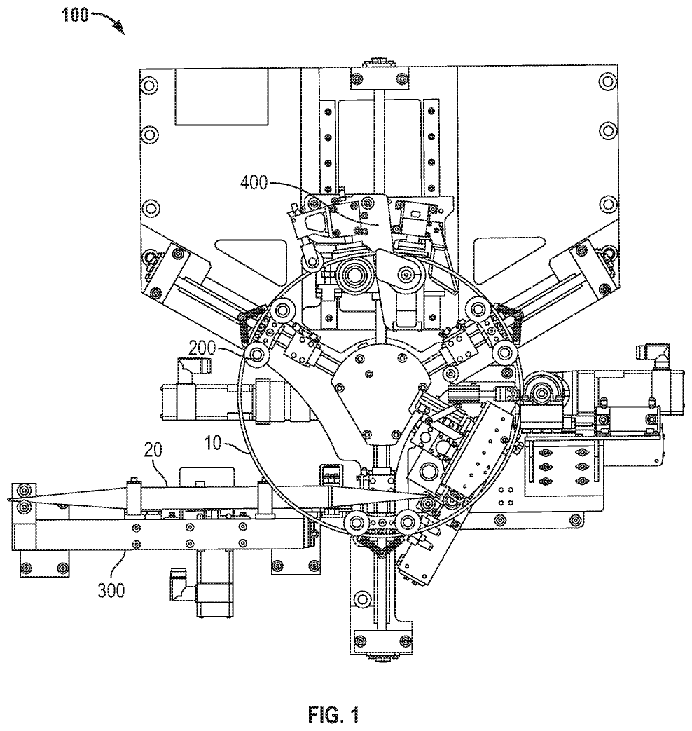

FIG. 1 shows a bead wrapping system 100 for wrapping a band/strip of a material (often referred to as “tape”), such as an elongated strip of a rubber material or another material (herein referred to as the “strip 20”), around the outer surface of a tire bead 10. The bead wrapping system 100 may generally include an expandable chuck 200 for handling the bead 10 (alone and when wrapped by the strip 20), a strip handling system 300 for handling the strip 20 prior to being wrapped around the bead 10, and a former assembly 400 for manipulating the strip 20 around the bead 10 and/or securing the strip 20 to the bead 10. Other components may additionally be included, such as strip/tape extrusion or storage equipment, bead formation and/or handling equipment, or the like.

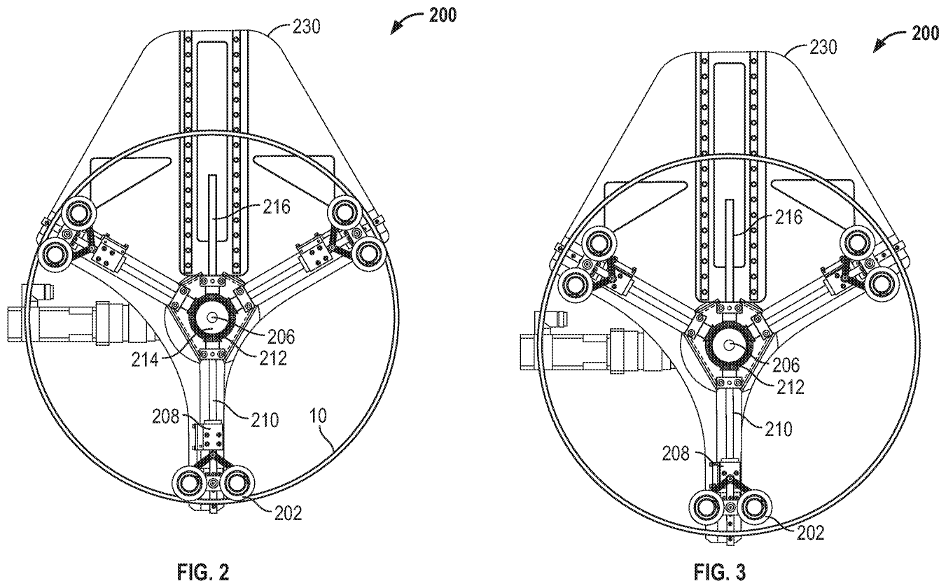

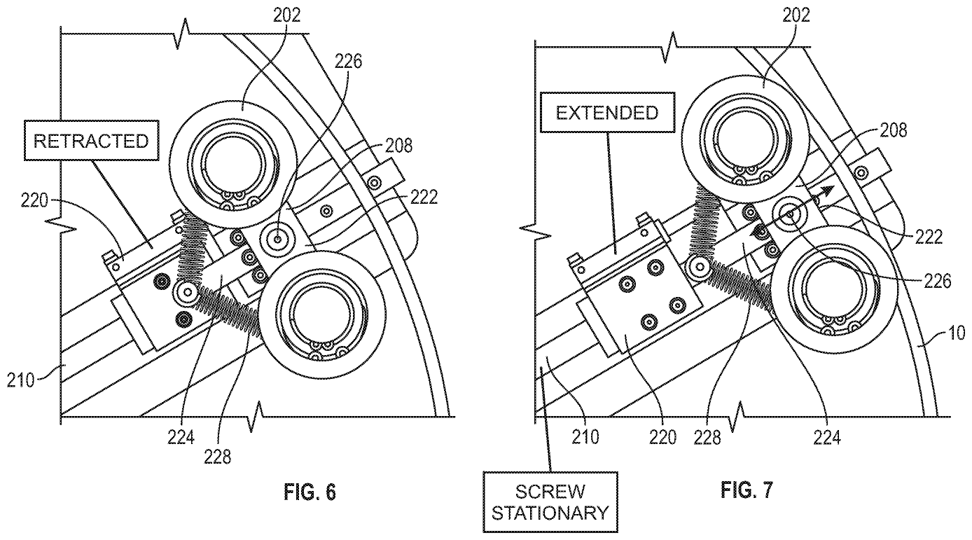

FIGS. 2-7 show the expandable chuck 200. While the expandable chuck 200 is described herein as a component of the bead wrapping system 100, the expandable chuck 200 may be used for other purposes, such as for holding any generally ring-shaped component, including (but not limited to) a tire bead (e.g., during bead formation and/or during the application of an apex), a bead-apex assembly, another ring-shaped component, and/or any other suitable substantially component. When the bead 10 is engaged by the expandable chuck 200, one or more rollers 202 of the expandable chuck 200 may directly contact the inner diameter of the bead 10 to provide support. In the depicted embodiment, three sets of rollers 202 are included, where each set includes two rollers 202, and where each set of rollers 202 is located at 120-degree increments around the outer perimeter of the expandable chuck 200. This embodiment is advantageous for providing sufficient support of the bead 10 while also providing room inside the inner diameter of the bead 10 for other components (i.e., portions of the strip handling system 300 shown in FIG. 1, for example). More or fewer rollers are also contemplated. While the rollers 202 may be driven (e.g., coupled to a motor or another device for causing rotation of the bead 10), the rollers 202 are idlers in the depicted embodiment.

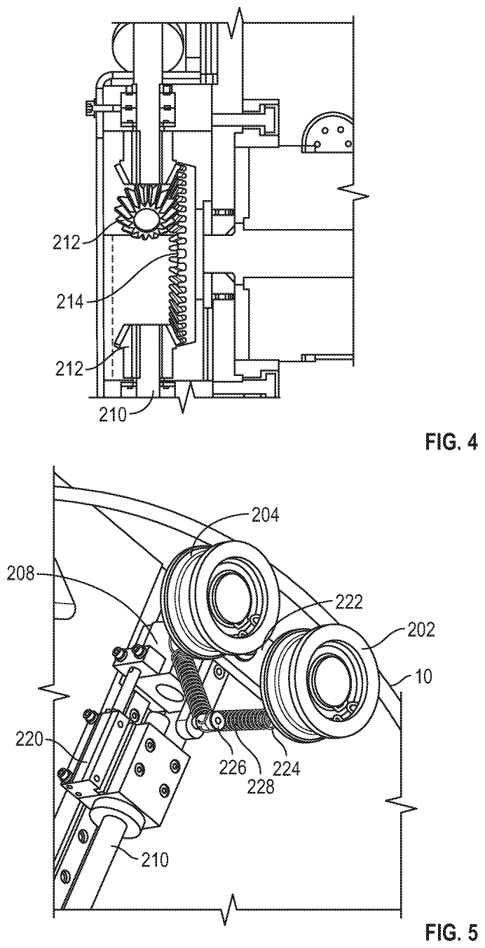

The rollers 202 of the expandable chuck 200 may be movable radially to engage with, and disengage with, the inner diameter of the bead 10, and/or to adapt to tire beads of different sizes. As shown in FIG. 5, the rollers 202 may be profiled with a groove 204 and/or another profile characteristic to receive and retain the bead 10 when engaged. The groove 204 may have about the same profile (but slightly larger) as the inner diameter of the bead 10 such that the bead 10 is substantially immovable axially when received by the groove 204. In other embodiments, the profile of the groove 204 may be configured (e.g., sized and shaped) to shape a strip around the bead 10 (as shown in FIG. 30).

Referring to FIGS. 2-3, the expandable chuck 200 may include an engaged state (shown in FIG. 2) and a disengaged state (shown in FIG. 3). In the engaged state, the rollers 202 may contact the inner diameter of the bead 10 to support and hold the bead in place, to cause movement of the bead (e.g., if the chuck itself rotates and/or if at least one of the rollers 202 is driven), etc. In the disengaged state, the effective diameter (or the diameter defined by an outer contact point of the rollers 202) of the expandable chuck 200 may be smaller than the inner diameter of the bead 10 such that the bead 10 can be removed from the expandable chuck 200. The expandable chuck 200 may switch from the engaged state to the disengaged state by moving at least one roller 202, and perhaps all the rollers 202, radially-inward towards center 206 of the expandable chuck 200.

The inward and outward radial movement of the rollers 202 may be caused by any suitable device. For example, referring to FIGS. 2-5, the rollers 202 may each be attached to a roller base 208, which may be linearly movable in the radial direction. In some embodiments, the roller base 208 may include female threads that correspond with threads on the outer surface of a screw rod 210. As a result, when the screw rod 210 rotates, it may cause the roller base 208 to move along its length (e.g., when the screw rod 210 rotates in a first direction, the roller base 208 may move radially outward, whereas if the screw rod 210 rotates in an opposite second direction, the roller base 208 may move radially inward). The screw rod 210 may be fixed to a bevel gear 212 such that when the bevel gear 212 rotates, the screw rod 210 also rotates, thereby causing radial movement of the roller base 208 (and the rollers 202). Rotation of the bevel gear 212 may be accomplished by driving (i.e., rotating) a central gear 214 (which may also be a bevel gear), where the central gear 214 is mechanically coupled to each of the bevel gears 212. Each of the three sets of rollers 202 may include a corresponding roller base 208, screw rod 210, and bevel gear 212 such that rotation of the central gear 214 moves each set of rollers 202 together. Thus, in this embodiment, the effective diameter of the expandable chuck 200 can be directly controlled by driving the central gear 214.

An auxiliary screw rod 216 may be included with its own bevel gear 218 that is mechanically coupled to the central gear 214. In some embodiments, the auxiliary screw rod 216 may be a “driven rod” controlling rotation of the central gear 214. For example, the auxiliary screw rod 216 may be mechanically coupled to a motor or another device for rotating the auxiliary screw rod 216, and/or the auxiliary screw rod 216 may be configured to be rotated manually (e.g., by hand). Since rotating the auxiliary screw rod 216 will cause rotation of the central gear 214, the auxiliary screw rod 216 may provide an interface by which the effective diameter of the expandable chuck 200 is controlled. In other embodiments, the central gear 214 may be controlled in another way (e.g., a motor may be coupled to the central gear 214 through a shaft extending along the central axis of the expandable chuck 200). In these embodiments, the auxiliary screw rod 216 may be coupled to another device or system (such as at least a portion of the strip handling system 300 and/or the former assembly 400 shown in FIG. 1), thereby advantageously providing automatic adjustment of multiple aspects of the bead wrapping system 100 to accommodate beads of different sizes.

Referring to FIGS. 5-7, each of the rollers 202 may be coupled to an actuator 220 capable of moving the rollers 202 linearly (i.e., in addition to, or as an alternative to, rotation of a screw rod). For example, the actuator 220 may include a servo motor, a pneumatic device, etc. The actuator 220 may be coupled to, or included as part of, the roller base 208, and thus the actuator 220 may move when the roller base 208 moves (e.g., due to rotation of the screw rod 210 as described above). When the actuator 220 is included in addition to the above-described screw rod 210, the actuator 220 may be utilized for making fine or relatively small adjustments to the radial roller position, whereas the screw rod 210 may be utilized for making general adjustments. In one application, the screw rod 210 may be manipulated during machine setup to accommodate a bead of a certain size, and the actuator 220 may be utilized for moving the rollers 202 between the engaged and unengaged states (i.e., to remove a wrapped bead and replace it with an unwrapped bead).

Optionally, when the rollers 202 are included in pairs (such as in the depicted embodiments), the rollers 202 may be fixed to a bracket 222, and each end of the bracket 222 (i.e., one end corresponding to each of the rollers 202) may be secured to the roller base 208 via a spring 228. Additionally or alternatively, a picket arm 224 may also secure the bracket 222 to the roller base 208, where the bracket 222 may rotate relative to the picket arm 224 (e.g., when the rollers 202 pivot to adapt to varying topography of the inner diameter of the bead 10). Each of the springs 228 may provide a variable degree of extension relative to an attachment point 226 of the roller base 208. Advantageously, this embodiment may allow the rollers 202 to adapt to varying profiles or surface characteristics of the inner diameter of the bead 10 by pivoting. For example, when rubber (e.g., via a strip or tape) is applied to the outer surface(s) of the bead 10, the change in the inner-diameter dimension (e.g., due to the thickness of the rubber) can be accounted for without moving the roller base 208 and/or without damaging the rubber. The springs 228 may also include a selected spring constant that provides a particular compression on the inner diameter of the bead 10, thus ensuring the bead 10 is suitably secured on the expandable chuck 200 and/or to press a strip against the bead with a particular force (e.g., as shown in FIG. 30).

When incorporated into the bead wrapping system 100, the center 206 of the expandable chuck 200 may remain substantially fixed relative to the general housing components of the bead wrapping system 100. A frame member 230 may fix the center 206 to such components. The frame member 230 may include an opening or another feature that secures the central gear 214 in place (e.g., in a manner such that the central gear 214 can rotate).

Advantageously, the expandable chuck 200 may provide expansion without rotating or substantially changing its size or orientation (e.g., the screw rods 210 do not move for example), thus preventing obstruction or interference with other equipment (such as the strip handling system 300, for example). In other embodiments, the bead wrapping system 100 may include a different chuck (or other device) for supporting the bead and/or strip during the bead wrapping process. For example, in some embodiments, the bead wrapping system 100 may utilize a center expanding chuck for as disclosed by U.S. patent application Ser. No. 13/837,233 to Gorham (“Gorham”), which published as U.S. Publication No. 2014/0265400 and issued as U.S. Pat. No. 8,939,486. This application is hereby incorporated by reference in its entirety.

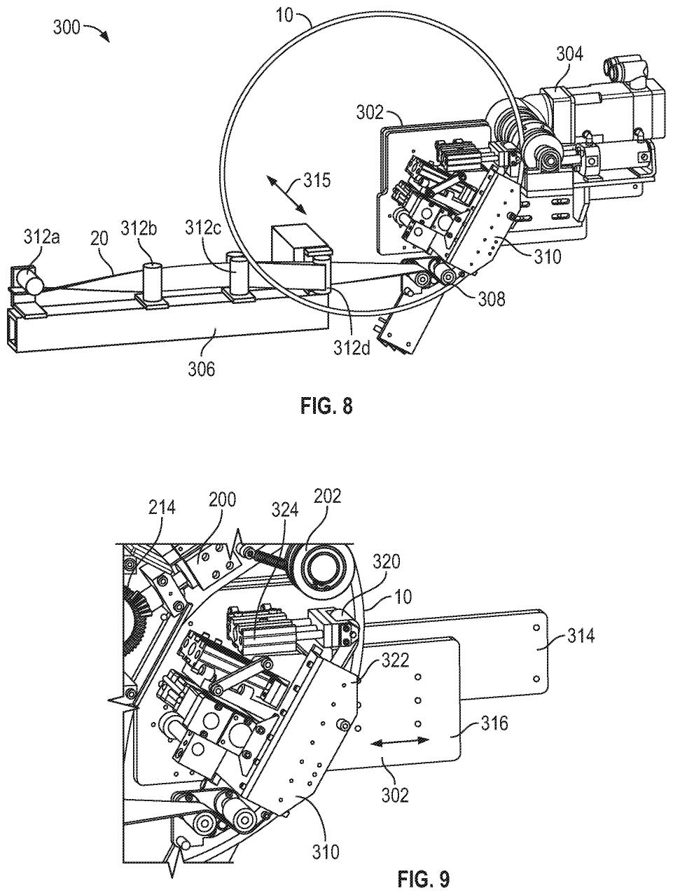

FIG. 8 shows the strip handling system 300 in isolation (along with the bead 10). The strip handling system 300 may generally include a diameter adjustment assembly 302, a drive assembly 304, a feed assembly 306, an entrance assembly 308, and a cutter assembly 310. These assemblies are described in more detail below with reference to FIGS. 8-26.

Referring to FIG. 8, the feed assembly 306 may include a plurality of feed rollers 312 that guide the strip 20 towards the entrance assembly 308. For example, a first feed roller 312a may be located downstream from a drum for storing the strip 20, a strip extruder, etc. One or more feed rollers, in this embodiment a second feed roller 312b and a third feed roller 312c, may rotate the strip 20 (i.e., about an axis parallel to its longitudinal direction) such that its width dimension (i.e., the largest cross-sectional dimension) is parallel to a plane defined by the perimeter of the bead 10. Advantageously, by rotating the strip 20 into this orientation, the strip 20 can bypass the bead 10 as it moves into a position radially inside the inner diameter of the bead 10. In other words, if the strip 20 did not rotate, the bead 10 itself may be an obstruction preventing the strip 20 from moving to a location radially inside the inner diameter of the bead 10), but rotation of the strip 20 initiated by the second feed roller 312b overcomes this potential issue. A fourth feed roller 312d, which may be located radially inside the inner diameter of the bead, may be movable in the direction 315 to align the strip 20 with the entrance assembly 308 (i.e., since the entrance assembly 308 may be movable in the direction 315 as described in more detail below). The entrance assembly 308 may include rollers that rotate the strip back into proper orientation for wrapping, as described in more detail below.

Once the strip 20 exits the entrance assembly 308, it may extend into and through the cutter assembly 310. After exiting the cutter assembly 310, the strip 20 may be driven, along with the bead 10, by the drive assembly 304, where the drive assembly 304 directly influences (e.g., causes) the rotation of the bead 10 and the movement of the strip 20. Certain portions of the entrance assembly 308, the cutter assembly 310, and/or the drive assembly 304 may be movable radially via the diameter adjustment assembly 302 to accommodate beads of different sizes, and/or to allow loading and unloading of unwrapped and/or wrapped beads.

Referring to FIGS. 9-11, the diameter adjustment assembly 302 may include a base 314 and a support plate 316, where the support plate 316 is movably-secured to the base 314 (e.g., by mounting the support plate 316 to the base 314 via a linear actuator 318). Optionally, the support plate 316 (and/or the base 314) may be mounted to the auxiliary screw rod 216 (FIG. 2) such that the components mounted to the support plate 316 may move along with the rollers 202 of the expandable chuck 200, described above (see, e.g., FIG. 2). This embodiment may be advantageous since a single adjustment (i.e., driving the central gear 214 of the expandable chuck 200 shown in FIG. 2) may alter multiple portions of, or the entirety of, the bead wrapping system 100 to accommodate a bead of a different size.

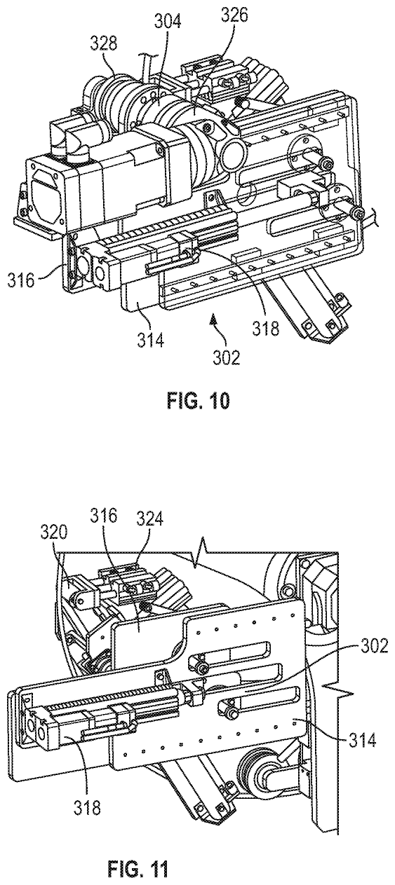

As shown in FIG. 9, an inner drive roller 320 of the drive assembly 304 may be mounted near an exit 322 of the cutter assembly 310 via a linear actuator 324. This may be advantageous for allowing the inner drive roller 320 to selectively engage and disengage the inner diameter surface of the bead 10, which may facilitate starting and stopping bead wrapping, as described in more detail below. As shown in FIG. 10, the rest of the drive assembly 304 (such as a drive actuator 326 and an outer drive roller 328) may also be mounted to the support plate 316 such that it moves as the support plate 316 moves, but alternatively the drive actuator 326 and the outer drive roller 328 may be mounted to the base 314 (or another component). FIG. 11 shows a back perspective view of the embodiment of FIGS. 9-10, including the drive assembly 304 attached to the support plate 316. As shown in FIG. 11, the support plate 316 is attached to the base 314 through the linear actuator 318. FIG. 11 shows the diameter adjustment assembly 302 in a state where the support plate 316 moved radially-outward relative to its position in FIG. 10 (and thus FIG. 11 may correspond to an engaged state where FIG. 11 corresponds to a disengaged or loading/unloading state).

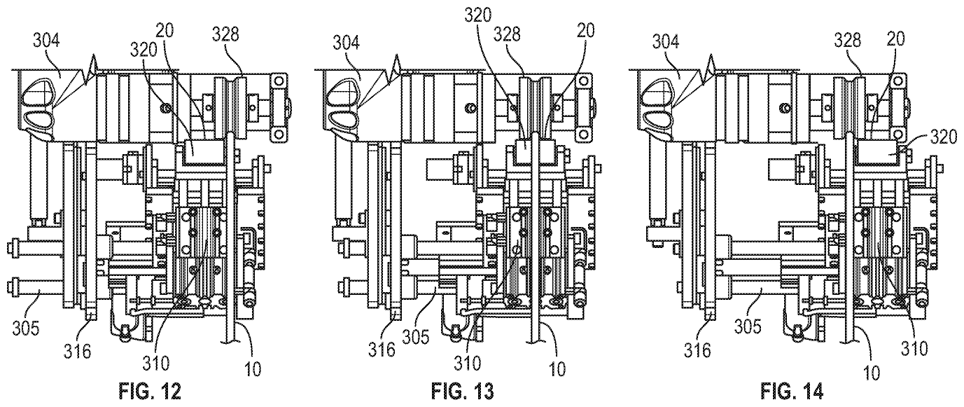

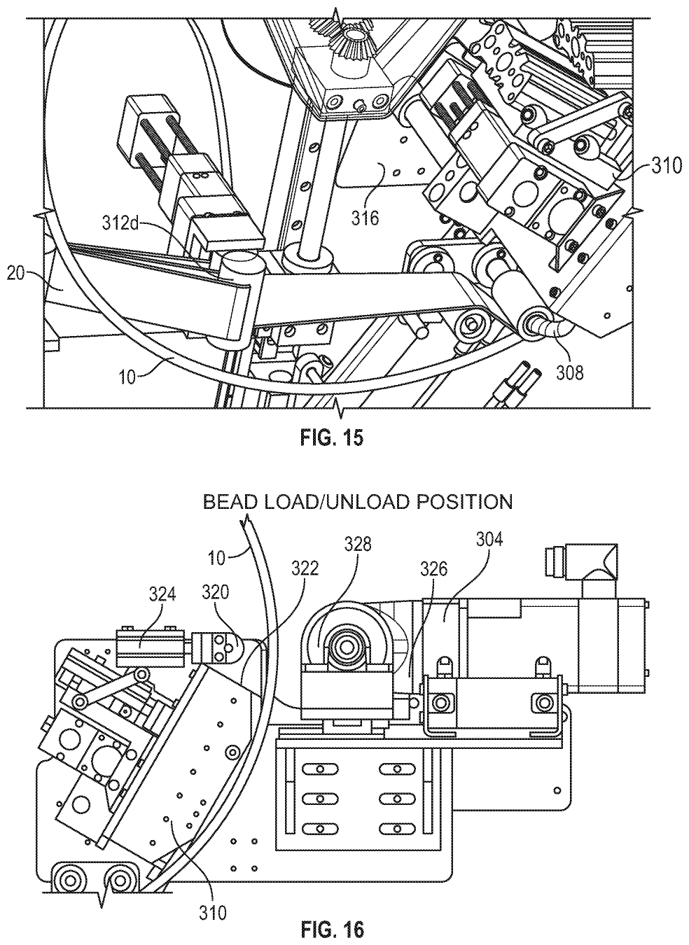

In some embodiments, the support plate 316 (or at least a portion thereof), and/or another base/holding device may be movable axially (i.e., along the direction parallel to the rotational axis of the bead 10) to adjust the axial feed position of the strip 20 relative to the bead 10, which may be advantageous for adjusting the attack angle and/or the splice/overlap location of the strip 20 as it is wrapped around the bead 10. For example, referring to FIG. 12, the inner drive roller 320 and the cutter assembly 310 (and therefore also the strip 20 itself) are adjusted to the left of center relative to the outer drive roller 328 of the drive assembly 304 and the bead 10. This adjustment may be accomplished by sliding certain components along a shaft 305. In FIG. 13, the inner drive roller 320 and the cutter assembly 310 (and therefore also the strip 20) are centered relative to the outer drive roller 328 of the drive assembly 304 and the bead 10. In FIG. 14, the inner drive roller 320 and the cutter assembly 310 (and therefore also the strip 20) are located to the right relative to the outer drive roller 328 of the drive assembly 304 and the bead 10. Each of these positions may be associated with a different angle of attack, and/or a different splice location, of the strip 20 once the strip 20 is wrapped around the bead 10. Notably, referring to FIG. 15, the fourth feed roller 312d may also move with the support plate 316 (though the same actuator, or a different actuator as shown), thus ensuring the strip 20 remains in a suitable orientation and position as it reaches the entrance assembly 308, the cutter assembly 310, and the drive assembly 304.

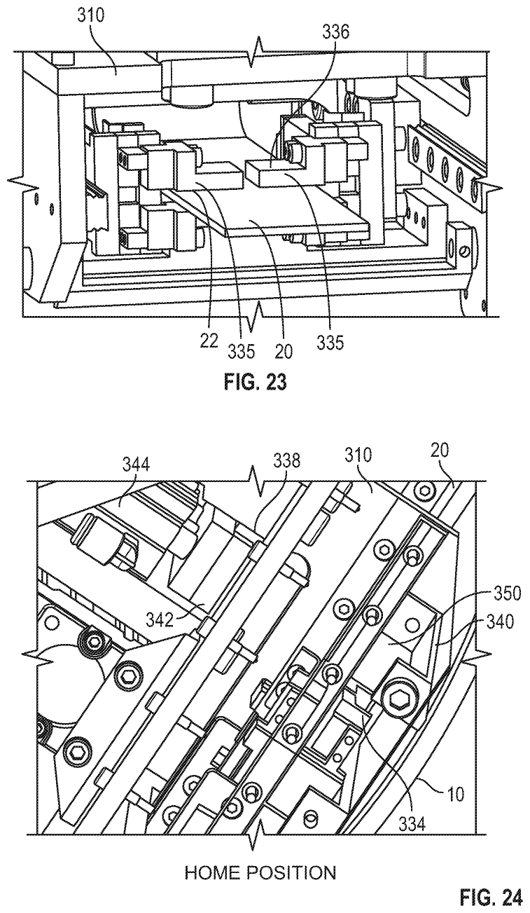

FIGS. 16-18 show various views of the drive assembly 304. As shown, the drive assembly includes the outer drive roller 328, which may have a groove 330 for receiving the bead 10 and/or strip 20, and an inner drive roller 320. The inner drive roller 320 may be movable relative to the outer drive roller 328 (e.g., via the actuator 324 shown in FIG. 16) to provide room (when disengaged) such that a bead 10 and/or strip 20 can be loaded. The outer drive roller 328 may be coupled to the drive actuator 326, which may be a motor or other suitable device for providing a drive force to the bead 10 and/or strip 20. While the inner drive roller 320 may also be driven, it is an idler in the depicted embodiment. As described above, the inner drive roller 320 may also be movable axially (i.e., with the cutter assembly 310) to adjust the angle of attack of wrapping, and/or the splice location of the strip 20. The outer drive roller 328 and the inner drive roller 320 may each be located near the exit 322 of the cutter assembly 310 such that the strip 20 is picked up by the drive assembly 304 once it is pulled through the cutter assembly 310. This location may be advantageous since, when a new wrapping process is initialized, and end of a strip 20 may be initially accepted by the drive assembly 304 just as it leaves the exit 322 of the cutter assembly 310 (e.g., by way of grippers described below with reference to FIG. 23).

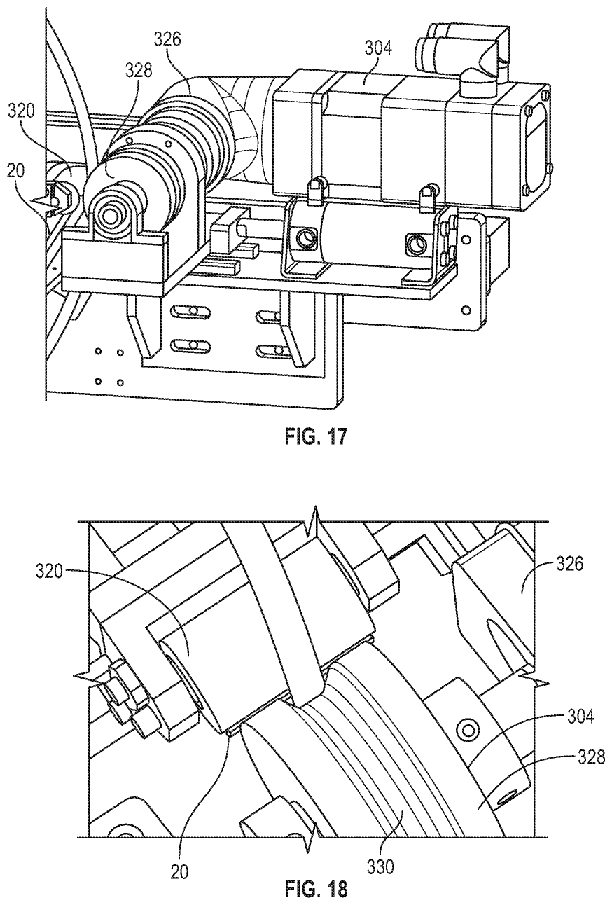

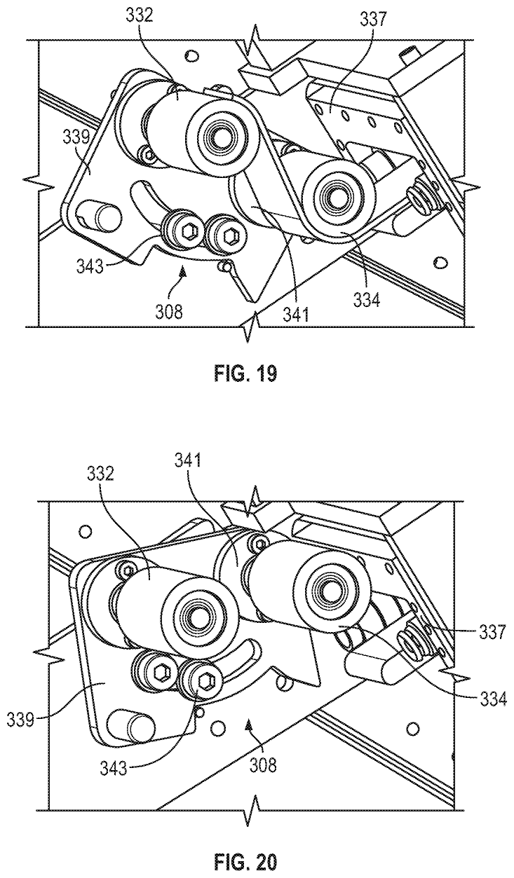

FIG. 19 and FIG. 20 show the entrance assembly 308, including a first entrance roller 332 and a second entrance roller 334. More or less entrance rollers may be included. The entrance assembly 308 may be located adjacent to an inlet 337 of the cutter assembly 310, and may be configured (e.g., sized, shaped, positioned, etc.) to properly orient and locate the strip 20 for entry into the cutter assembly 310 via the inlet 337. Optionally, the first entrance roller 332 may be movable relative to the second entrance roller 334 (e.g., by moving/rotating the first plate 339 relative to the second plate 341 by selectively tightening or loosening the fastener 343). This may be advantageous for adapting the entrance assembly 308 to different input feed orientations, for example. Other embodiments of the entrance assembly 308 are also contemplated (e.g., in some embodiments, only one input roller or no input rollers may be included).

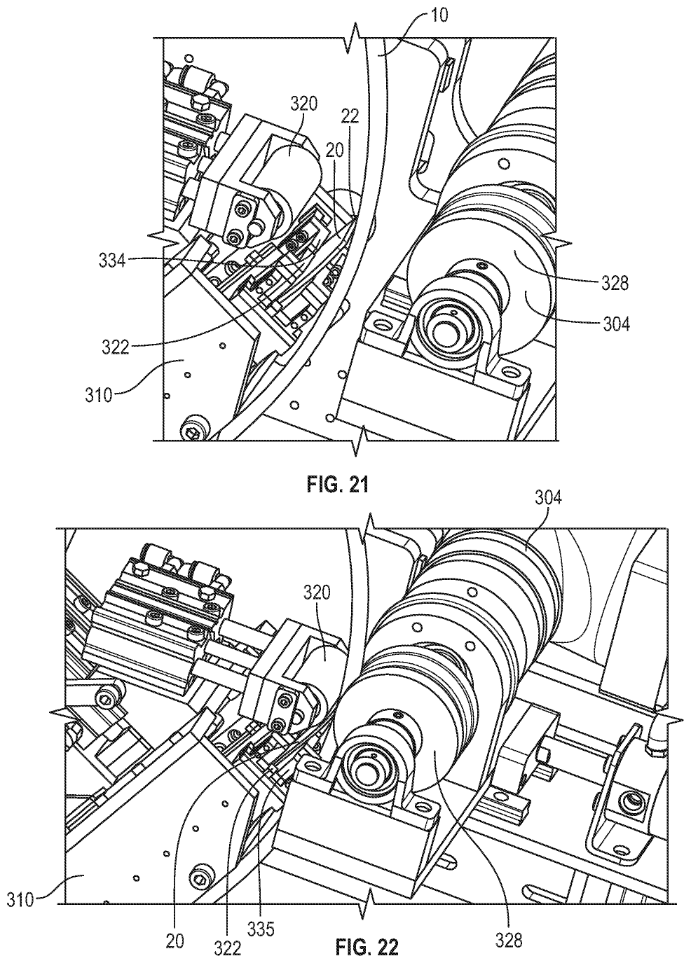

FIGS. 21-22 show the exit 322 of the cutter assembly 310, where an end 22 of the strip 20 is approaching the bead 10 when wrapping is initialized. For example, the end 22 of the strip 20 may be a leading end of a new roll of the strip 20, and/or it may be an end that was cut from a portion used in a prior bead-wrapping procedure. When the strip 20 reaches the location of FIG. 21, the inner drive roller 320 may move towards the strip 20 until it makes contact with the strip 20 and presses the strip 20 to the bead 10, as shown in FIG. 22. Similarly (but not shown), the outer drive roller 328 may move towards the bead 10 (or may already be in contact with the bead 10). Compression on the bead 10 and the strip 20 between the two drive rollers may cause the bead 10 and the strip 20 to move together (e.g., due to friction) as the outer drive roller 328 drives bead rotation. Further, this compression may cause the end 22 of the strip 20 to stick to the bead 10 even as it rotates away from the drive assembly 304 towards formation equipment (as described in more detail below).

Movement of the end 22 of the strip 20 before it reaches the drive assembly 304 may be caused by another device, such one or more grippers 335 shown in FIG. 23 (and also shown in FIGS. 21-22). Referring to FIG. 23, the grippers 335 may be included in the cutter assembly 310, and may use pneumatic devices, electromechanical devices, or other devices to pinch a location upstream of the end 22 of the strip 20 with the gripper arms 336. The gripper arms 336 may then move along the longitudinal axis of the strip 20 (e.g., through actuation of a linear actuator that is mechanically coupled to the gripper arms 336) to feed the end 22 of the strip 20 towards the drive assembly 304 (as shown in FIG. 21). Once the strip 20 is engaged by the drive assembly 304, as shown in FIG. 22, the grippers 335 may release the strip 20 such that movement of the strip 20 is controlled by the drive assembly 304. The grippers 335 may then retract back to their home position within the cutter assembly 310.

In addition to the grippers 335, the cutter assembly 310 may include a device configured to cut the strip 20. For example, the device may cut the strip 20 after a sufficient length of the strip 20 has been fed through the cutter assembly 310 to extend along the entire perimeter of the bead 10 (or, if multiple layers are wrapped around the bead, enough to form the entirety of the final layer). Referring to FIGS. 24-26, a blade 338 may be included along with a cutter bar 340 that forces the strip 20 into sufficient engagement with the blade 338 such that the blade 338 can separate the strip 20 into multiple portions. The blade 338 may be attached to a blade body 342 that moves linearly upon operation (e.g., through operation of a blade actuator 344).

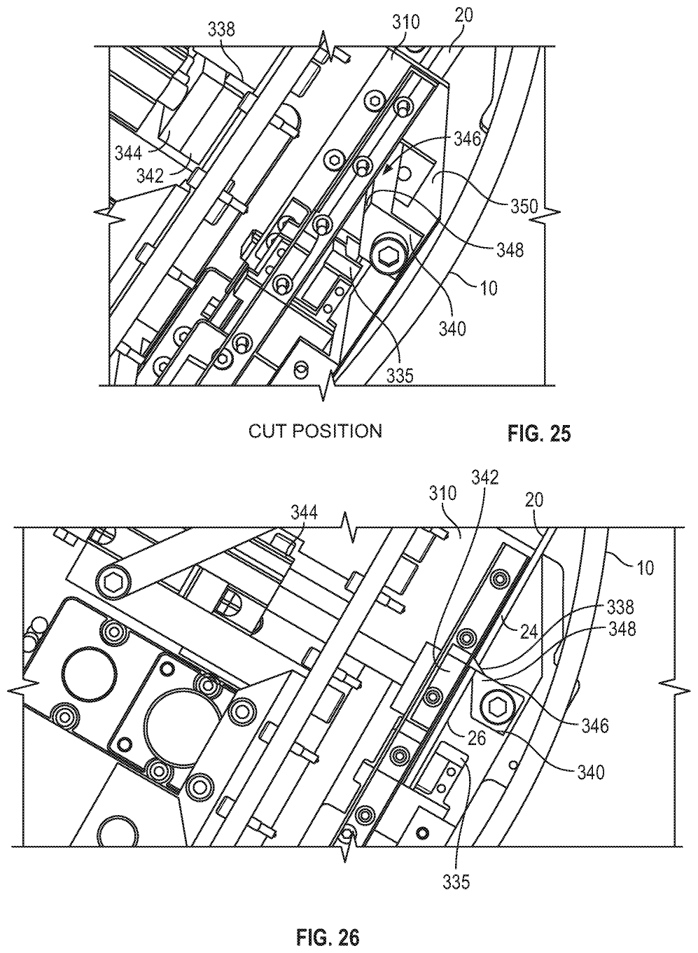

FIG. 25 shows the blade 338 prior to a cutting procedure, and FIG. 26 shows the blade 338 during a cutting procedure and where it has pierced and extended through the strip 20 to separate a first portion 24 of the strip 20 from a trailing second portion 26 of the strip 20. As shown in FIG. 26, the blade 338 extends adjacent to a side surface 346 of the cutter bar 340, and the strip 20 may be retained in place by a support surface 348 of the cutter bar 340 as the blade 338 extends therethrough. The grippers 335 may engage the second portion 26 of the strip 20 to hold the second portion in place until it is time for the second portion 26 to be wrapped around a bead (e.g., after unloading the bead 10 and loading a new bead).

In some embodiments, the cutter bar 340 may be movable to prevent obstructing other components. For example, the cutter bar 340, in its “cut” or “cutting” position in FIG. 24, may block the grippers from moving through the cutter assembly 310 to feed the strip 20 towards the drive assembly 304 (see FIG. 21). To solve this problem, the cutter bar 340 may be rotatable such that the support surface 348 and the side surface 346 can be moved such that they do not obstruct linear movement of the grippers 335. For example, the cutter bar 340 may be shaped to form a void 350. When the cutter bar 340 is not being used for a cutting procedure, and/or when it is time to initialize a wrapping procedure by moving a leading end of the strip 20 towards the drive assembly as described above, the cutter bar 340 may be rotated into its “home” or default position shown in FIG. 24 such that the void 350 is aligned with the grippers 335. When the cutter bar 340 is in this “home” position, the grippers 335 can pass through the void 350 (e.g., without making contact with the cutter bar 340) as they feed the leading end of the strip 20 towards the drive assembly. When it comes time to cut the strip 20 (typically when the grippers 335 are retracted), the cutter bar 340 may again be rotated into the position shown in FIG. 25.

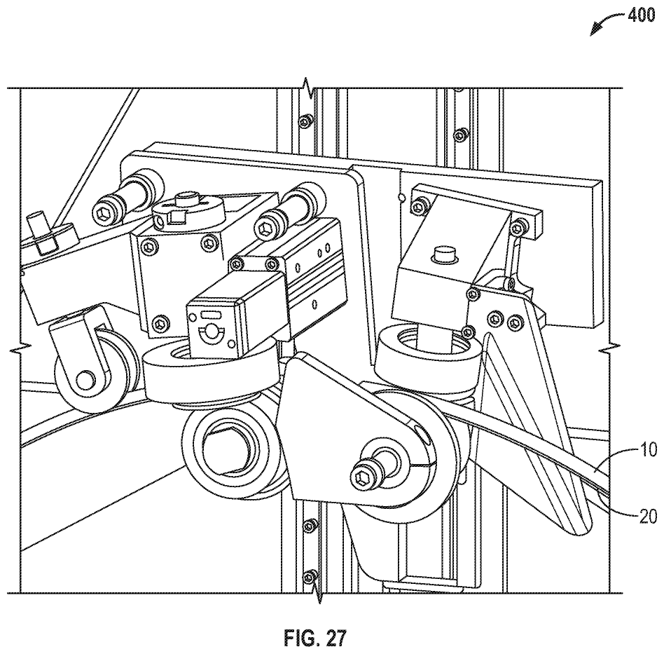

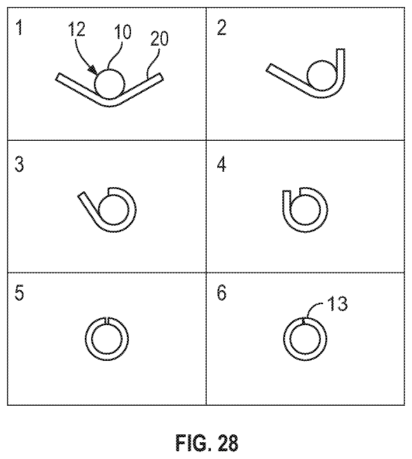

FIG. 27 shows the former assembly 400, which may generally include a set of rollers or other elements configured to wrap and press a strip of rubber around a bead 10. While many configurations are contemplated, the configuration of FIG. 27 is specifically suited to wrap the strip 20 (shown wrapped in FIG. 27) around the bead 10 in the six-step sequence depicted in FIG. 28. Optionally, the former assembly 400 may be mounted to the auxiliary screw rod 216 (FIG. 2) such that it may move along with the rollers 202 of the expandable chuck 200, described above (see, e.g., FIG. 2). This embodiment may be advantageous such that a single adjustment (i.e., driving the central gear 214 of the expandable chuck 200 shown in FIG. 2) may alter multiple portions of, or the entirety of, the bead wrapping system 100 to accommodate a bead of a different size.

For example, FIG. 28 shows six sequential steps for wrapping a strip 20 around a tire bead 10. Referring to FIG. 28, a first step may include aligning and pressing the strip 20 to a corresponding portion (e.g., a bottom portion) of an outer surface 12 of the bead, where the bottom of the outer surface 12 corresponds to the bead's inner diameter. As shown, the strip 20 may be centered relative to the center-point of the bead 10, but this is not required (e.g., when the seam 13 and/or a splice/overlapped portion of the strip 20 are desired to be located in a different location). The specific alignment may be adjusted to provide a desired seam location (see seam 13) and/or a desired wrap angle. In a second step, the strip 20 may be pressed against another portion of the outer surface 12. Steps 3-4 are similar, where each step includes pressing the rubbers strip 20 against a respective surface portion of the bead 10.

As shown, the tire bead 10 may be circular, but other cross-sectional shapes are also contemplated. For example, the cross section of the bead 10 may be triangular, rectangular, pentagonal, hexagonal, or the like. For example, if the bead 10 has a certain number of flat surfaces (e.g., when the bead 10 is triangular, rectangular, pentagonal, hexagonal, etc.), one step may be included to press the strip 20 to each of the flat surfaces, and more or fewer steps may be provided.

In a sixth step, the strip 20 may form the seam 13 (e.g., by providing a downward pressure with a finishing roller (as described below) by forcing ends of the strip 20 together. While not required (particularly when the strip 20 includes a sufficient degree of tackiness), an adhesive may be included on the ends of the strip 20 to seal the ends together. While not shown, this step may form a splice, or overlapped portion of strip 20, and may press an outer portion of the splice to an inner portion of the splice with sufficient force (with or without adhesive) to finish the wrapping process.

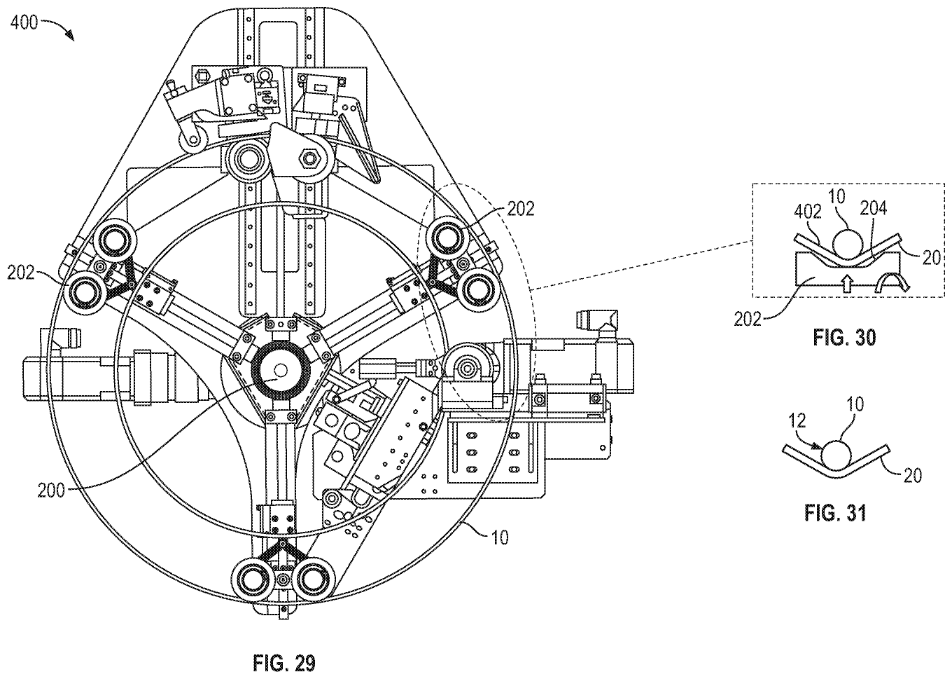

FIGS. 29-30 show relevant portions of the former assembly 400 at the first step (depicted in FIG. 31). As shown by FIGS. 29-30, the strip 20 may be pressed against the outer surface 12 (e.g., at the inner diameter portion) of the bead 10 due to being lodged between the outer surface 12 of the bead 10 and an outer-diameter surface 402 of the roller 202 (e.g., within the optional groove 204 of the roller 202). In other words, the roller 202, which may be a component of the expandable chuck 200 described above, may act as a forming surface that facilitates wrapping the strip 20 around the bead 10. As described above, the roller 202 may be mounted via a spring 228 (shown in FIG. 5), and the spring 228 may have a suitable spring constant to provide suitable compression to the strip 20.

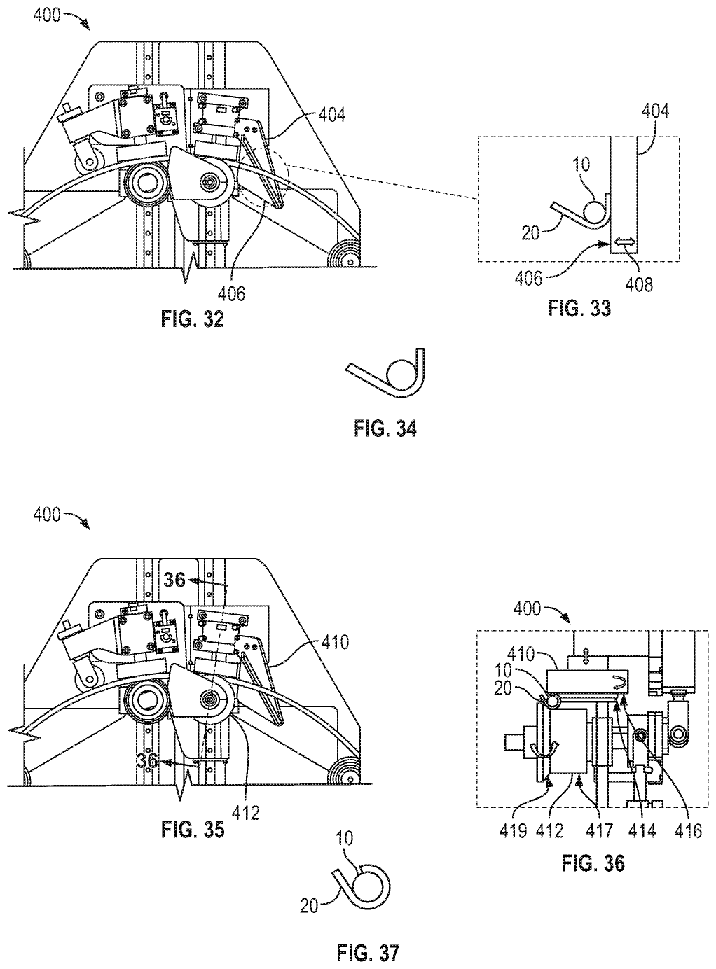

FIGS. 32-33 show relevant portions of the former assembly 400 at the second step (depicted in FIG. 34). As shown in FIGS. 32-33, a first forming plate 404 may be included in the former assembly 400 for shaping or otherwise influencing the strip 20 partially around the bead 10, and particularly around the lower-right portion of the bead 10 from the perspective of FIG. 34. In other words, referring to FIG. 32, as the bead 10 and the strip 20 rotate together (in the counter-clockwise direction from the perspective of FIG. 32), the first forming plate 404 will contact the underside 28 of the strip 20 as it passes by such that it is forced to wrap around the side of the bead 10. In FIG. 34, the right side of the strip 20 is depicted as being forced into a vertical orientation, which may be an orientation compatible with downstream rollers or other equipment described below. The first forming plate 404 may include a contact surface 406 that is lubricated or otherwise configured (e.g., sized, shaped, textured, etc.) to contact the strip 20 without snagging or otherwise obstructing the desired movement of the strip 20. In some embodiments, the first forming plate 404 may be movable in the direction 408 (either manually or automatically), or in another direction, to accommodate beads and/or strips of different sizes, different desired compressions of the strip 20, or the like.

FIGS. 35-36 show relevant portions of the former assembly 400 at the third step (depicted in FIG. 37). As shown in FIGS. 32-33, the third step of wrapping the strip 20 around the bead 10 may utilize a first forming roller 410 and a second forming roller 412. The first forming roller 410 and the second forming roller 412 may optionally be angled relative to one another (e.g., they may have rotational axes that are perpendicular as shown), but other roller orientations are also contemplated.

Each of the first forming roller 410 and the second forming roller 412 may include at least one forming surface that presses the strip 20 against the outer perimeter of the bead 10 when the strip 20 is lodged between the bead 10 and the respective roller. For example, in the depicted embodiment, the first forming roller 410 includes a first forming surface 414 and a second forming surface 416 that each press the strip 20 onto a respective outer surface of the bead 10. The first forming surface 414 and the second forming surface 416 of the first forming roller 410 may be angled relative to one another (e.g., to mirror the relative angles of the outer surfaces of the bead 10). Similarly, the second forming roller 412 may include a third forming surface 417 and a fourth forming surface 419 that correspond. Like the first forming plate 404 described above, the first forming roller 410 and/or the second forming roller 412 may be movable for compatibility with beads and/or strips of different sizes, and/or to vary the degree of compression provided.

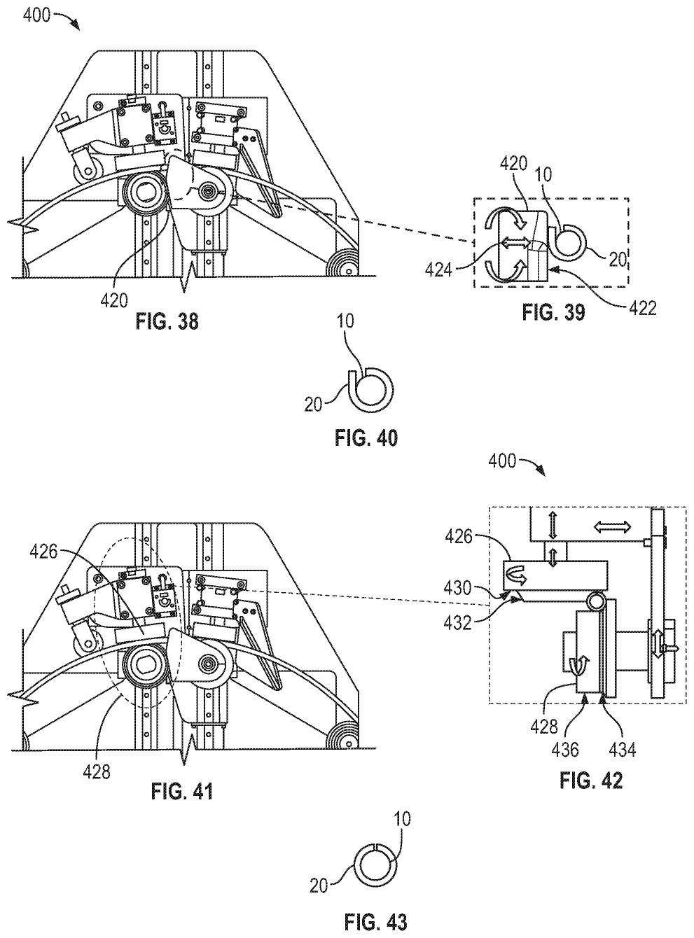

FIGS. 38-39 show relevant portions of the former assembly 400 at the fourth step (depicted in FIG. 40). As shown in FIGS. 38-39, the fourth step of wrapping the strip 20 around the bead 10 may utilize a second forming plate 420. The second forming plate 420 may be similar to the first forming plate 404 described above. For example, the second forming plate 420 may have a contact surface 422 that contacts the strip 20 as the bead 10 and the strip 20 rotate together (in the counter-clockwise direction from the perspective of FIG. 38). As a result, in FIG. 40, the left side of the strip 20 is forced into a vertical orientation, which may be an orientation compatible with downstream rollers or other equipment. The second forming plate 420 may be lubricated or otherwise configured (e.g., sized, shaped, textured, etc.) to contact the strip 20 without snagging or otherwise obstructing the desired movement of the strip 20. In some embodiments, the second forming plate 420 may be movable in the direction 424 (either manually or automatically), or in another direction, to accommodate beads and/or strips of different sizes, different desired compressions of the strip 20, or the like.

FIGS. 41-42 show relevant portions of the former assembly 400 at the fifth step (depicted in FIG. 43). As shown in FIGS. 41-42, the fifth step of wrapping the strip 20 around the bead 10 may utilize a third forming roller 426 and a fourth forming roller 428. The third forming roller 426 and the fourth forming roller 428 may optionally be angled relative to one another (e.g., they may have rotational axes that are perpendicular as shown), but other roller orientations are also contemplated.

Each of the third forming roller 426 and the fourth forming roller 428 may include at least one forming surface that presses the strip 20 against the outer perimeter of the bead 10 when the strip 20 is lodged between the bead 10 and the respective roller. For example, in the depicted embodiment, the third forming roller 426 includes a fifth forming surface 430 a sixth forming surface 432 corresponding to respective outer surfaces of the bead 10. The fifth forming surface 430 and the sixth forming surface 432 may be angled relative to one another (e.g., to mirror the relative angles of the respective bead surfaces). Similarly, the fourth forming roller 428 may include a seventh forming surface 434 and an eighth forming surface 436. Like the other forming rollers and/or guide plates described above, one or more of the third forming roller 426 and the fourth forming roller 428 may be movable for compatibility with beads and/or strips of different sizes, and/or to vary the degree of compression provided.

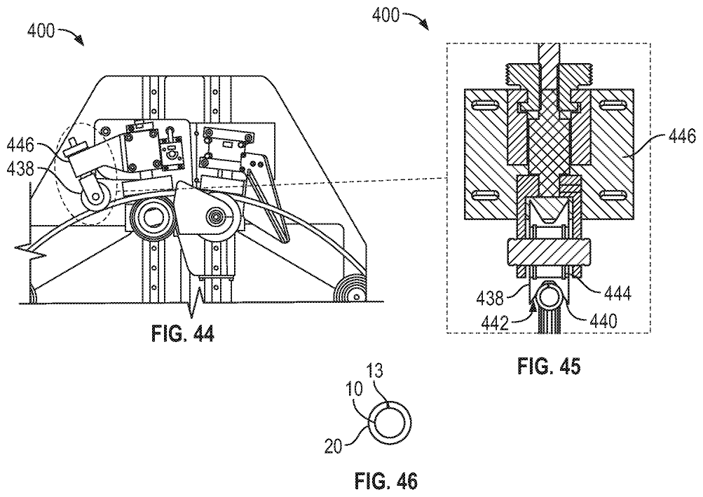

FIGS. 44-45 show relevant portions of the former assembly 400 at the sixth step (depicted in FIG. 46). As shown in FIGS. 44-45, the sixth step of wrapping the strip 20 around the bead 10 may utilize a fifth forming roller or finishing roller 438. The finishing roller 438 may include a groove 440 having side walls 442 that are appropriately angled to press the strip 20 against corresponding perimeter surfaces of the bead 10, and/or to press the ends of the strip 20 together to form a seam 13 (FIG. 46). One notable difference between the finishing roller 438 and the rollers 202 of the expandable chuck 200 (FIG. 2) is that the finishing roller 438 shown in FIG. 45 engages the bead 10 from a location outside of the outer diameter of the bead 10 rather than from inside the inner diameter.

The groove 440 of the finishing roller 438 may be sized such that it is compatible with beads and/or strips of different sizes (e.g., assuming the cross-sectional shape of the bead 10 remains substantially the same). For example, beads of smaller sizes may be located closer to a floor surface 444 of the groove 440 than beads of larger sizes during the strip wrapping process. Optionally, the finishing roller 438 may additionally or alternatively be movable (e.g., vertically from the perspective of FIG. 45) to accommodate beads and/or strips having different dimensions. Additionally or alternatively, the finishing roller 438 may be secured to a support member 446 via a spring such that the finishing roller 438 can auto-adjust to beads and/or strips of different sizes and also provide appropriate compression to ensure that the strip 20 is properly wrapped around the bead 10.

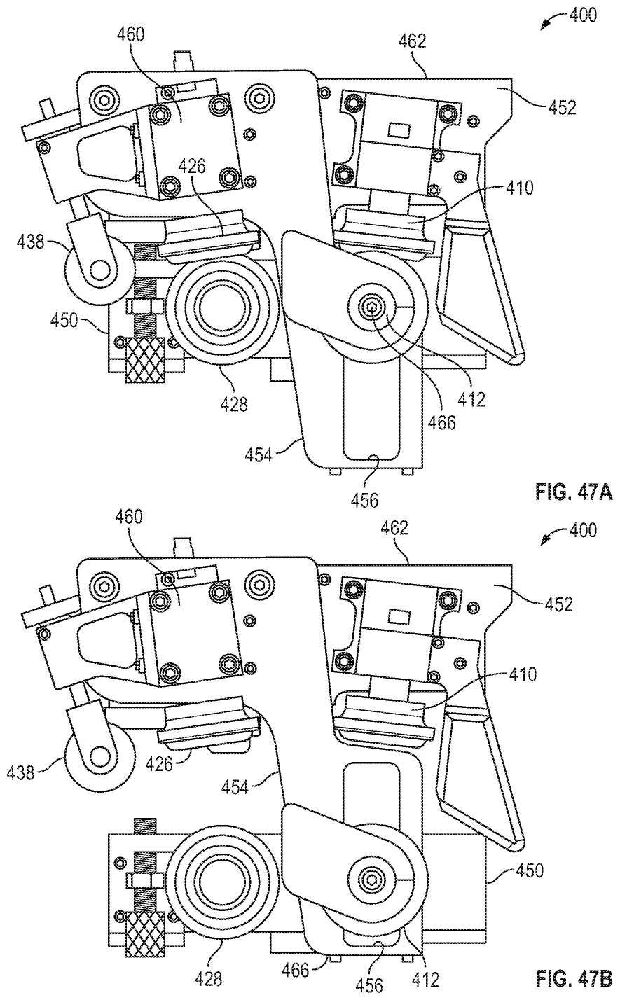

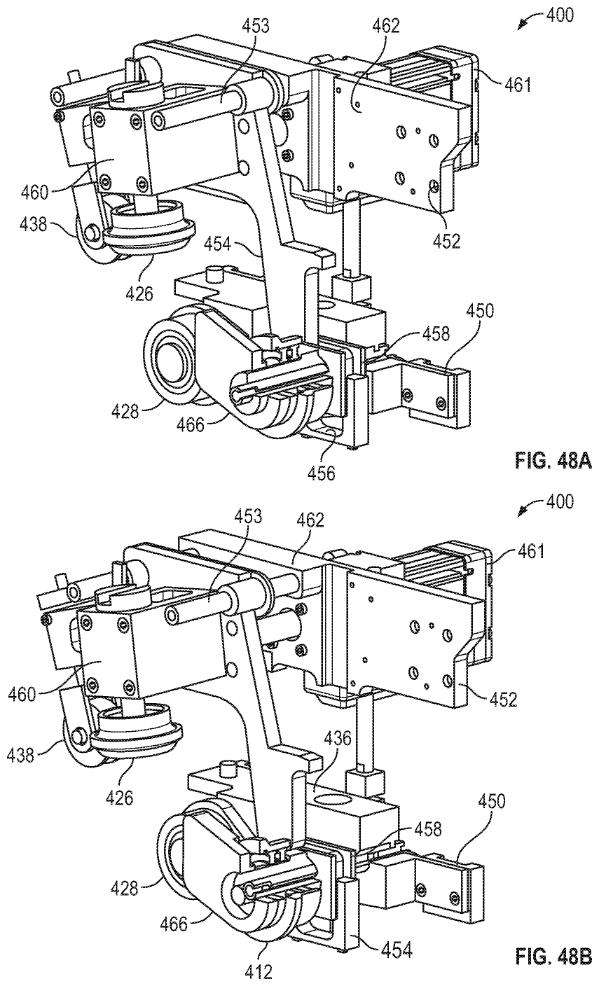

FIGS. 47A-47B show a front view of the former assembly 400 in two states: an open state (FIG. 47A) and a closed state (FIG. 47B). In the open state, the bottom former rollers (i.e., the second former roller 412 and the fourth former roller 428) are moved away from a forming state, and are spaced a distance from the upper former rollers (i.e., the first former roller 410 and the third former roller 426). For example, the second former roller 412 and the fourth former roller 428 may be attached to a bottom former base 450, the first former roller 410 and the third former roller 426 may be attached to a top former base 452, where the bottom former base 450 is movable relative to the top former base 452. In the depicted embodiment, a bracket 454 with a slot 456 is fixed to the top former base 452. The bottom former base 450 is fixed to a slide 458 (shown in FIGS. 48A-48B) that is slidable within the slot 456 (i.e., with one degree of motion corresponding to the vertical direction from the perspective of FIGS. 47A-47B. This vertical motion may be caused by actuation of an actuator 461, and/or by another suitable device or method (either automatically or manually). Advantageously, the top and bottom rollers of the former assembly 400 may allow for loading and unloading of a bead (e.g., when the rollers are spaced apart), and then the top and bottom rollers may collapse together around a bead at the initiation of the bead wrapping process.

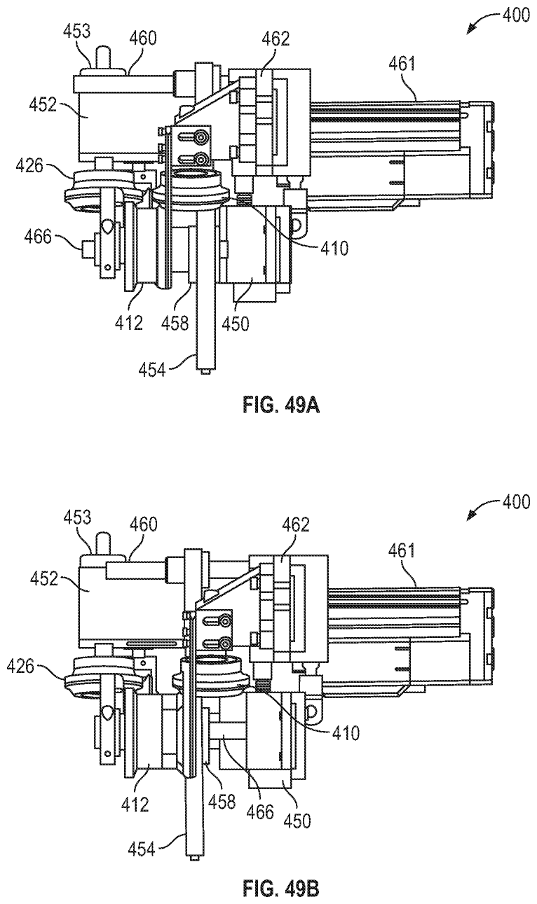

Similarly, referring to FIGS. 48A-48B and FIGS. 49A-49B, the former assembly 400 may be collapsible in a second direction such that the front rollers (i.e., the second former roller 412 and the third former roller 426) are movable axially relative to the back former rollers (i.e., the first former roller 410 and the fourth former roller 428). The closed state (FIG. 49A) may be an operational state for bead wrapping, where the open state (FIG. 49B) may be a loading and/or unloading state. In the depicted embodiment, such axial may be provided by a movable portion 460 of the top former base 452. The movable portion 460 may be slidably mounted on at least one shaft 453 that extends from a fixed portion 462. The bracket 454 may be attached to the movable portion 460 such that the bracket 454 is movable axially with the movable portion 460. Such movement may be provided manually or via an actuator, for example.

As shown, the first former roller 410 may be directly secured (e.g., fixed) to the movable portion 460, and thus the first former roller 410 may move axially when the movable portion 460 moves axially. The fourth former roller 428 may be slidable on a shaft 466, where the shaft 466 is fixed relative to the bottom former base 450. Thus, when the bracket 454 moves axially with the movable portion 460, the slide 458 may be forced to move by the edges of the slot 456, which may result in the fourth former roller 428 moving axial with the slide 458 and slide 458 and bracket 454. Advantageously, the front and back rollers of the former assembly 400 may allow for loading and unloading of a bead (e.g., when the rollers are spaced apart), and then the front and back rollers may collapse together around a bead at the initiation of the bead wrapping process.

Referring back to FIG. 1, once the bead 10 and strip 20 move past the finishing roller 438, the bead 10 is in a wrapped configuration. After a full revolution, the bead 10 is fully wrapped by the strip 20. Additional revolutions may occur to form multiple layers. After completion of all wrapping layers, the expandable chuck 200 and/or other components may be moved into the above-described disengaged state and the wrapped bead 10 may be unloaded from the bead wrapping system 100. Afterward, a new bead 10 may be loaded and/or the bead wrapping system 100 may be adjusted to wrap a bead with different dimensions.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. An expandable chuck, comprising:
a plurality of rollers forming an effective diameter of the expandable chuck;
a central gear located at the center of the expandable chuck;
at least one drive rod mechanically coupled to the central gear; and
at least one roller base secured to at least one roller of the plurality of rollers,
wherein rotation of the central gear causes the at least one roller base to move linearly along the drive rod.

2. The expandable chuck of claim 1, wherein the expandable chuck comprises:
a plurality of rollers forming an effective diameter of the expandable chuck;
a central gear located at the center of the expandable chuck;
at least one drive rod mechanically coupled to the central gear; and
at least one roller base secured to at least one roller of the plurality of rollers,
wherein rotation of the central gear causes the at least one roller base to move linearly along the drive rod.

3. The expandable chuck of claim 2, wherein the roller base is coupled to at least one roller, and wherein the roller is movable relative to the roller base between an extended position and a retracted position.

4. The expandable chuck of claim 2, wherein a picket arm is fixed from rotation relative to the roller base, wherein the roller is coupled to the picket arm via a bracket, and wherein the bracket is rotatable relative to the picket arm.

5. The expandable chuck of claim 4, wherein at least one spring applies a spring force on at least one end of the bracket.

6. The expandable chuck of claim 2, further comprising an auxiliary screw rod that is mechanically coupled to the central gear and extends radially away from the central gear, wherein the auxiliary screw rod is a driven rod that controls rotation of the central gear.

7. The expandable chuck of claim 2, further comprising an auxiliary screw rod that is a driven rod coupled to an actuator.

8. The expandable chuck of claim 2, further comprising an auxiliary screw rod that is mechanically coupled to a cutter such that rotation of the auxiliary screw rod moves the cutter radially relative to the central gear.

9. The expandable chuck of claim 2, wherein the central gear is a bevel gear, and wherein a gear fixed to an end of the drive rod is a bevel gear.

10. A bead wrapping system for wrapping a strip around a tire bead, the bead wrapping system comprising:
an expandable chuck;
a strip handling system; and
a former assembly,
wherein at least one of the strip handling system and the former assembly is movable radially relative to a central gear of the expandable chuck in response to rotation of the central gear.

11. The bead wrapping system of claim 10, wherein the expandable chuck comprises:
a plurality of rollers forming an effective diameter of the expandable chuck;
a central gear located at the center of the expandable chuck;
at least one drive rod mechanically coupled to the central gear; and
at least one roller base secured to at least one roller of the plurality of rollers,
wherein rotation of the central gear causes the at least one roller base to move linearly along the drive rod.

12. The bead wrapping system of claim 11, wherein the roller base is coupled to at least one roller, and wherein the roller is movable relative to the roller base between an extended position and a retracted position.

13. The bead wrapping system of claim 11, wherein a picket arm is fixed from rotation relative to the roller base, wherein the roller is coupled to the picket arm via a bracket, and wherein the bracket is rotatable relative to the picket arm.

14. The bead wrapping system of claim 13, wherein at least one spring applies a spring force on at least one end of the bracket.

15. The bead wrapping system of claim 11, further comprising an auxiliary screw rod that is mechanically coupled to the central gear and extends radially away from the central gear, wherein the auxiliary screw rod is a driven rod that controls rotation of the central gear.

16. The bead wrapping system of claim 11, further comprising an auxiliary screw rod that is mechanically coupled to the strip handling system such that rotation of the auxiliary screw rod moves the strip handling system.

17. The bead wrapping system of claim 11, further comprising an auxiliary screw rod that is mechanically coupled to the former assembly such that rotation of the auxiliary screw rod moves the former assembly.

18. The bead wrapping system of claim 11, wherein the central gear is a bevel gear, and wherein a gear fixed to an end of the drive rod is a bevel gear.

19. The bead wrapping system of claim 10, wherein the strip handling system comprises a cutter assembly, the cutter assembly comprising:
an entrance and an exit;
a gripper configured to engaged a strip and to move the strip from the entrance towards the exit;
a blade configured to cut the strip at a location between the entrance and the exit, and
a cutter bar that is rotatable between a cutting position and a default position, wherein the cutter bar includes a support surface configured to contact the strip when the cutter bar is in the cutting position; and
a drive assembly comprising at least one drive roller that is movable to engage and disengage the strip at the exit of the cutter assembly.

20. The bead wrapping system of claim 10, wherein the former assembly comprises:
a plurality of former rollers, the plurality of former rollers including at least a first former roller and a second former roller,
wherein the first former roller is movable in an axial direction relative to the second former roller and also in the radial direction relative to the second former roller.
